(19) United States
(12) Patent Application Publication
(10) Pub. No.: US 2004/0095769 A1
(43) Pub. Date: May 20, 2004

(54) Photoconductive structure of backlight module

(76) Inventors: Kuo Jui Huang, Chia-Yi Hsien (TW); Wen Hua Yang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/293,265

(22) Filed: Nov. 14, 2002

(51) Int. Cl. F21V 5/00

(52) U.S. Cl. 362/339; 362/326; 362/328; 362/329; 362/31

(57) ABSTRACT

Photoconductive structure of backlight module includes a photoconductive board, a light source, a reflecting board and a brightening film. One of top face and bottom face of the photoconductive board is formed with multiple photoconductive patterns which are concentric arches centered at the light source. The reflecting board is disposed on one face of the photoconductive board, while the brightening film is disposed on the other face of the photoconductive board. One of the top face and bottom face of the brightening film is formed with multiple focusing patterns arranged in the same aspect as the photoconductive patterns of the photoconductive board. Under action of the focusing patterns and the photoconductive patterns, the light beam projected from the light source is concentrated and goes out from the photoconductive board in the direction of the normal line of the photoconductive board.

### BACKGROUND OF THE INVENTION

The present invention is related to a photoconductive structure of backlight module, and more particularly to a photoconductive structure in which a focusing pattern of a brightening film and a photoconductive pattern of a photoconductive board are concentric arches centered at the light source. Under action of the focusing patterns and the photoconductive patterns, the light beam projected from the light source is concentrated and goes out from the photoconductive board in the direction of the normal line of the photoconductive board.

FIG. 7 is a top view of a conventional backlight module. A bottom face of a photoconductive board 71 is formed with multiple parallel linear photoconductive patterns 72 for properly conducting the light beam of the light source 73 toward the liquid crystal module (not shown).

Referring to FIG. 7, the light beams projected from the light source 72 are radially scattered. When the light beam L is projected to the photoconductive patterns 72, an angle α is contained between the light beam L and the photoconductive patterns 72. Accordingly, a refracted light L1 is outward scattered. This leads to declination of luminance. In order to solve this problem, the brightness or number of the light source must be increased. Under such circumstance, the power consumption will be increased.

Further referring to FIG. 8, when the light beam L is projected to the photoconductive patterns 72 which are V-shaped channels, a reflected light L2 is produced. The reflected light L2 and the normal line A of the photoconductive board 71 contain a predetermined reflection angle β. The smaller the reflection angle β is, the better the brightness of the normal light is. Reversely, the brightness of the normal light is weaker.

In order to rectify the reflection angle β to make the outgoing light beam near the normal line A of the photoconductive board 71, generally a brightening film 8 is laid on the photoconductive board 71. For example, 3M Company produces a brightening film 8 the bottom of which is formed with linear parallel focusing patterns 81. As shown in FIG. 8, the focusing patterns 81 are parallel to the photoconductive patterns 72, whereby under action of the focusing patterns 81, the reflected light L2 is rectified into the outgoing light L3 nearly in the direction of the normal line A of the photoconductive board 71. Accordingly, the brightness of the normal light is enhanced.

However, the declination of the brightness caused by scattering of the refracted light L1 takes place before the light beam goes into the brightening film 8. That is, only a part of the light beam of the light source 73 goes into the brightening film 8 to produce the necessary normal light. Therefore, with the brightening film 8, the backlight module still has the problem of insufficient luminance.

FIG. 9 shows another type of backlight module in which the photoconductive board 91 is formed with multiple arched photoconductive patterns 92 for properly conducting the light beam of the light source 93 toward the liquid crystal module (not shown).

The photoconductive patterns 92 are arched so that the angle α is contained between the light beam L of the light source 93 and the photoconductive patterns 92 is nearly 90. Therefore, the scattering and declination of the light beam caused by refraction can be effectively minified.

However, when the light beam L is projected to the photoconductive patterns 92 which are V-shaped channels as shown in FIG. 10, a reflected light L2 goes out. In general, the angle β contained between the reflected light L2 and the normal line A of top face of the photoconductive board 91 is about 30˜60.

With such angle, the brightness of the normal light is still insufficient. Therefore, although the arched photoconductive patterns 92 can minify the declination of the brightness, the 30˜60 outgoing angle β still fails to make the backlight module have sufficient normal light in visible range.

In the case that the brightening film 8 with the linear parallel focusing patterns 81 is disposed on the photoconductive board 91 with the arched photoconductive patterns 92, the arched photoconductive patterns 92 are nearly parallel to the focusing patterns 81 only in the area near the central line B of the photoconductive board 91. Therefore, the brightening film 8 can achieve brightening effect only in the area near the central line B of the photoconductive board 91 as shown in FIG. 11. FIG. 11 is a top view in which the photoconductive board 91 is overlapped with the brightening film 8. It is apparently seen in FIG. 11 that the photoconductive patterns 92 and the focusing patterns 81 nearly parallelly intersect each other only in the area near the central line B of the photoconductive board 91. The existent brightening film 8 can hardly strengthen the brightness of normal light of the photoconductive board 91 with the arched photoconductive patterns 92.

### SUMMARY OF THE INVENTION

It is therefore a primary object of the present invention to provide a photoconductive structure of backlight module. The photoconductive board is formed with multiple photoconductive patterns which are concentric arches centered at the light source. A brightening film is disposed on one face of the photoconductive board. The brightening film is formed with multiple focusing patterns arranged in the same aspect as the photoconductive patterns of the photoconductive board. Under action of the focusing patterns and the photoconductive patterns, the light beam projected from the light source is concentrated and goes out from the photoconductive board in the direction of the normal line of the photoconductive board. Therefore, the photoconductive efficiency of the photoconductive board is enhanced.

The present invention can be best understood through the following description and accompanying drawings wherein:

### BRIEF DESCRIPTION OF THE DRAWINGS

FIG. 1 is a perspective exploded view of the photoconductive structure of the present invention, showing the path of the light;

FIG. 2 is a top view of the photoconductive structure of the present invention, showing that the light beam is normal to the photoconductive patterns;

FIG. 3 shows the path of light beam of the present invention;

FIG. 4 shows a second aspect of the photoconductive patterns of the present invention;

FIG. 5 shows a third aspect of the photoconductive patterns of the present invention;

FIG. 6 shows a fourth aspect of the photoconductive patterns of the present invention;

FIG. 7 is a top view of a conventional backlight module, showing that the light beams are outward scattered;

FIG. 8 is a view of a conventional backlight module with a brightening film, showing the path of the light;

FIG. 9 is a top view of a conventional backlight module with arched photoconductive patterns, showing the angle contained between the light beam and the photoconductive patterns;

FIG. 10 is a view of a conventional backlight module with arched photoconductive patterns, showing the path of light; and

FIG. 11 is a top view of a conventional backlight module with arched photoconductive patterns and brightening film.

### DETAILED DESCRIPTION OF THE PREFERRED EMBODIMENTS

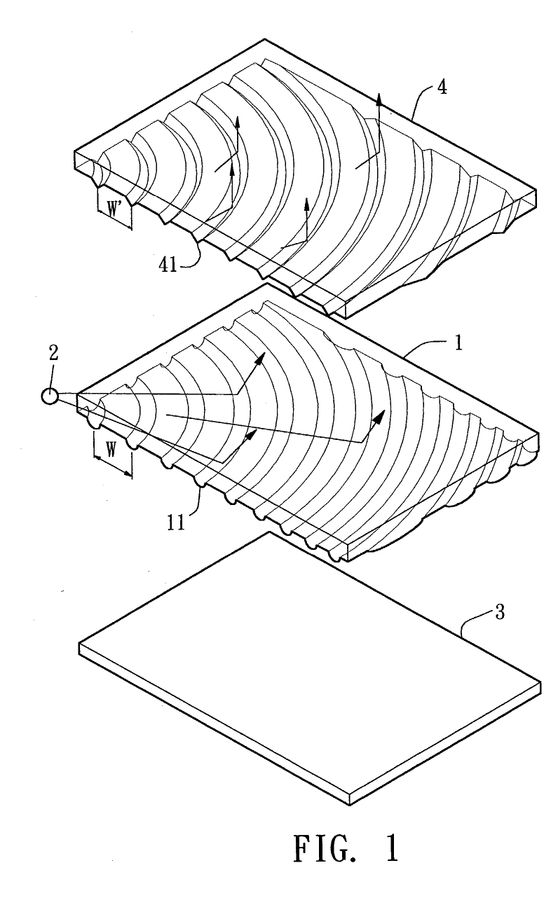

Please refer to FIGS. 1 to 3. The photoconductive structure of backlight module of the present invention includes a photoconductive board 1, a light source 2, a reflecting board 3 and a brightening film 4.

The light source 2 is positioned adjacent to a corner of the photoconductive board 1.

The bottom face of the photoconductive board 1 is formed with multiple photoconductive patterns 11, which are concentric arches, centered at the light source 2. In this embodiment, the cross-sections of the photoconductive patterns 11 are convex. The photoconductive patterns 11 are spaced from each other by distances W. The closer to the light source 2 the photoconductive patterns 11 are, the larger the distances between the photoconductive patterns 11 are. The distance W gradually narrows relative to the light source 2.

The reflecting board 3 is connected with the bottom face of the photoconductive board 1 for reflecting the light beam going out from the photoconductive board 1 toward the top face of the photoconductive board 1.

The brightening film 4 is disposed on top face of the photoconductive board 1. The bottom face of the brightening film 4 is formed with multiple focusing patterns 41. The focusing patterns 41 are concentric arches centered at the light source 2. In this embodiment, the cross-sections of the focusing patterns 41 are projecting V-shaped. The focusing patterns 41 are spaced from each other by distances W′. The distances W′ are equal to each other.

The photoconductive board 1 is manufactured in such a manner that a photo resistor is first painted on a glass substrate. Then by means of yellow light manufacturing procedure, photo resistor square microstructures, which are concentric arches, are manufactured. Then by means of heating, curved microstructures are formed. The diameter of the curved microstructure pattern is about 3 μm˜180 μm. The height thereof is about 4 μm˜70 μm. Then, by means of electroforming and mold turnover, an injection mold is made. By means of the injection mold, the photoconductive board 1 with the concentric photoconductive patterns 11 can be manufactured by injection molding. Finally, the outgoing angle θ for achieving maximum brightness of the photoconductive board 1 is measured as the reference value for manufacturing the brightening film 4.

The brightening film 4 is manufactured in such a manner that first by means of mechanical processing, a metal panel is processed to form the brightening structures, which are concentric arches. In this embodiment, the brightening structures are projecting V-shaped structures with a height of about 30 μm. The angle γ of the tip is equal to the outgoing angle θ for achieving maximum brightness of the photoconductive board 1. Then, the brightening film 4 made of PET material is placed on the metal panel and thermally pressed to duplicate the concentric brightening structures on the brightening film 4 to form the necessary focusing patterns 41.

Finally, the brightening film 4 is connected on the photoconductive board 1 with the circular center of the focusing patterns 41 aimed at the circular center of the photoconductive patterns 11.

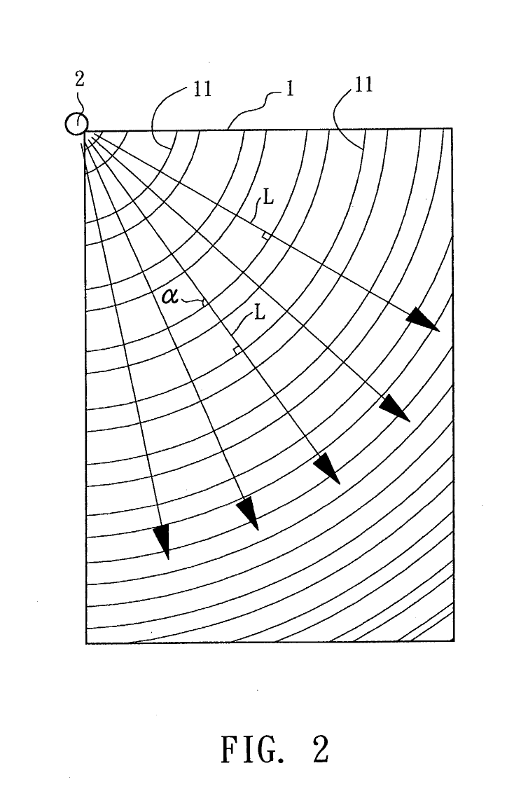

Referring to FIG. 2, the photoconductive patterns 11 are all concentric arches centered at the light source 2 so that the angle α contained between the light beam L projected from the light source 2 and the photoconductive patterns 11 is right angle. Accordingly, the light beam will not be outward scattered and declined. Therefore, the light beam L projected from the light source 2 is all reflected by the photoconductive patterns 11 and goes out to achieve better photoconductive efficiency.

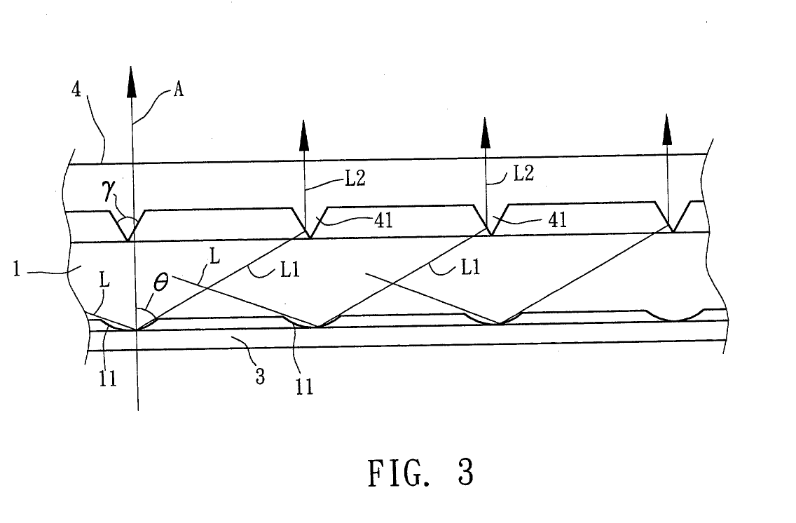

Further referring to FIG. 3, the focusing patterns 41 of the brightening film 4 are all parallel to the photoconductive patterns 11 of the photoconductive board 1. Therefore, after the light beam L goes into the photoconductive board 1 toward the photoconductive patterns 11, a reflected light L1 with outgoing angle θ is produced. After the reflected light L1 is projected to the focusing patterns 41 of the brightening film 4, the reflected light L1 is refracted by the focusing patterns 41 to produce outgoing light L2 nearly in the direction of the normal line A of the photoconductive board 1. Accordingly, the brightening film 4 can strengthen the brightness of the normal light.

It should be noted that the photoconductive patterns 11 of the photoconductive board 1 are concentric arches all centered at the light source 2. Therefore, by means of the photoconductive patterns 11, the light beam is prevented from outward scattering and declining. Furthermore, the focusing patterns 41 of the brightening film 4 and the photoconductive patterns 11 of the photoconductive board 1 are concentric arched all centered at the light source 2. Therefore, the focusing patterns 41 can conduct the light beam to go out nearly in the direction of the normal line A of the photoconductive board 1. Therefore, the brightness of the normal light is strengthened. Accordingly, the backlight module of the present invention only uses one single light source to achieve the necessary brightness so that the power consumption is effectively lowered and the manufacturing cost is reduced.

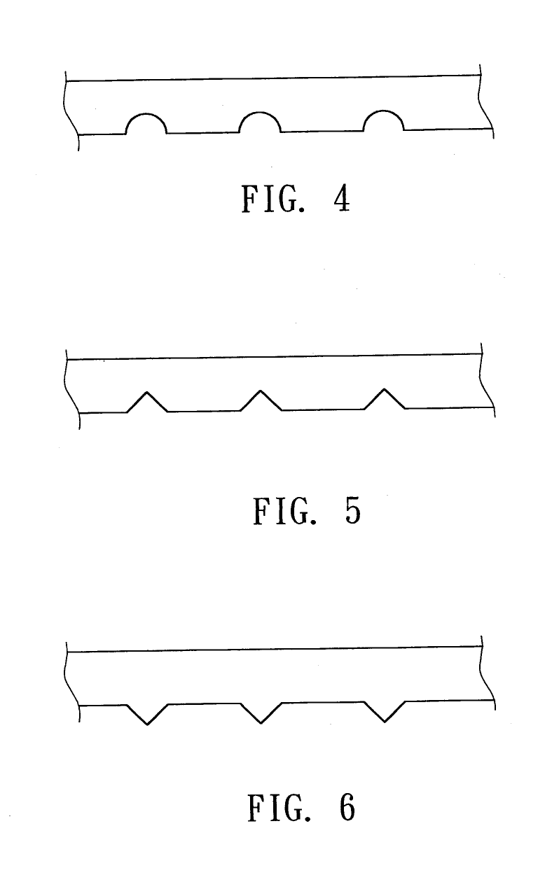

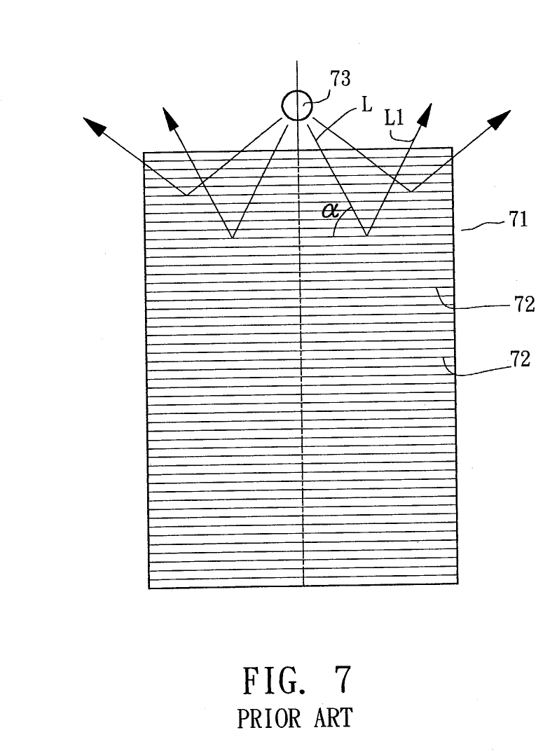

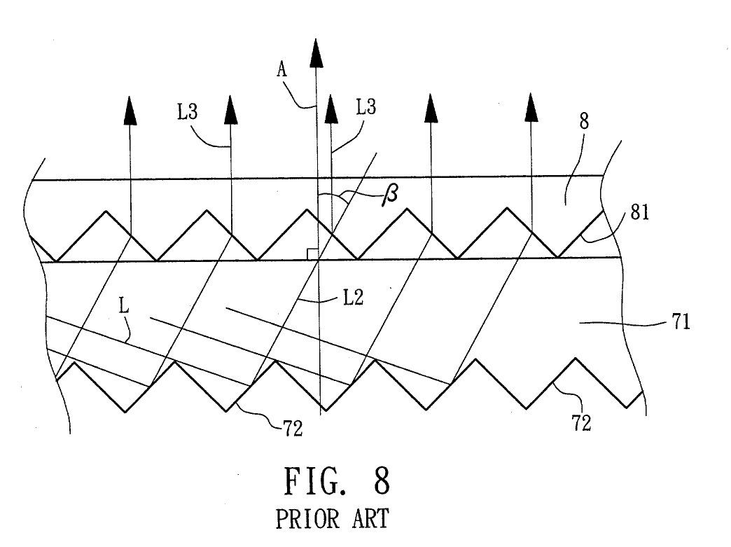

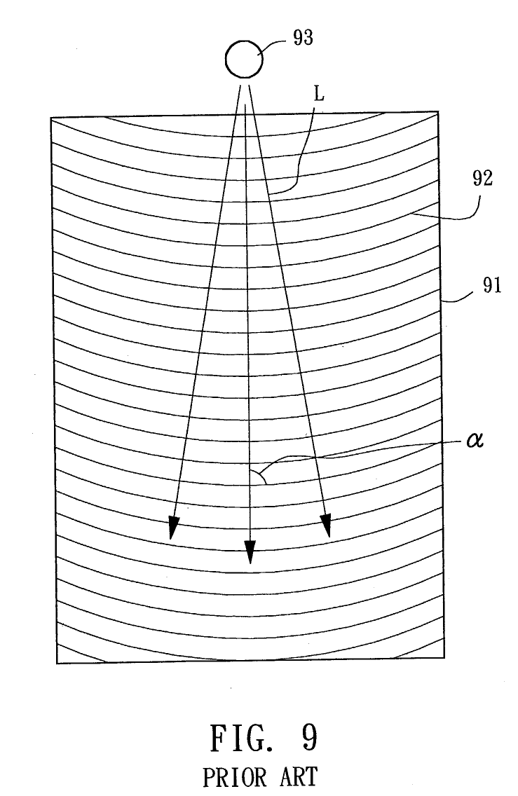

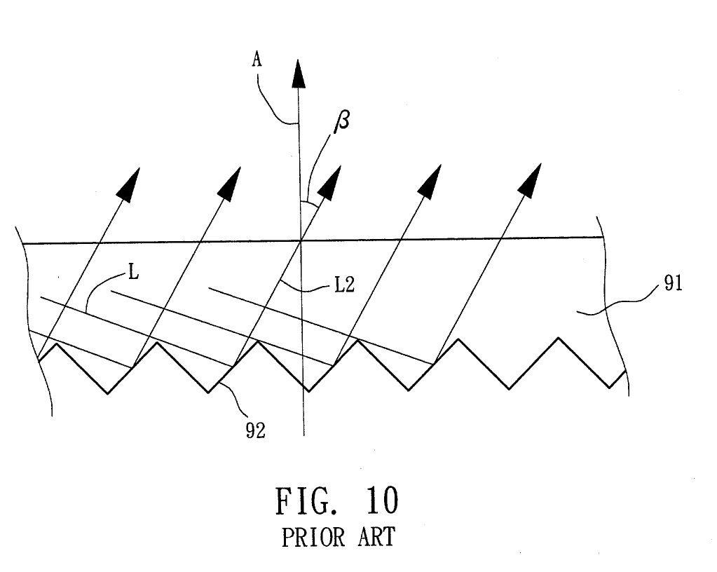

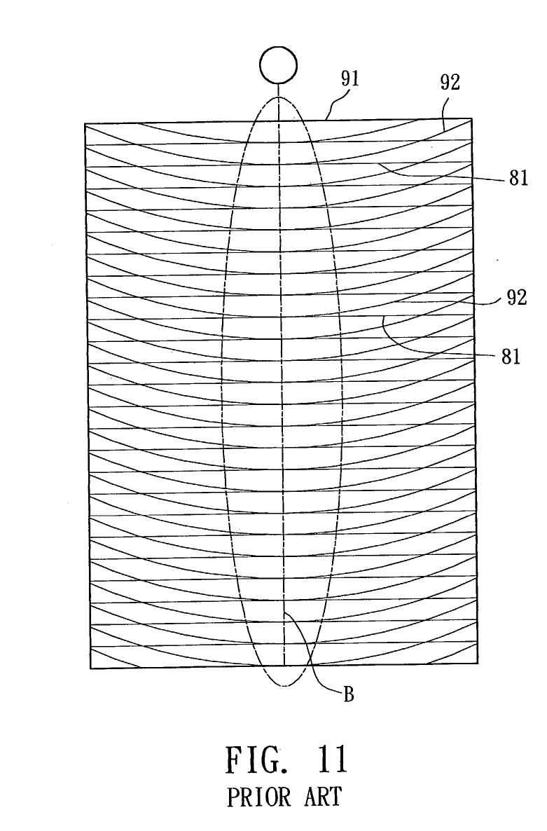

The above embodiment is only used to illustrate the present invention, not intended to limit the scope thereof. Many modifications of the above embodiment can be made without departing from the spirit of the present invention. For example, FIGS. 4 to 6 show some other embodiments of the present invention in which the photoconductive board 1 has different aspects of photoconductive patterns 11. In FIG. 4, the cross-section of the photoconductive pattern is concave. In FIG. 5, the cross-section of the photoconductive pattern is recessed and V-shaped. In FIG. 6, the cross-section of the photoconductive pattern projects and is V-shaped. These embodiments can also achieve the same effect as the first embodiment.

In still another embodiment, with respect to the focusing patterns of the brightening film, the closer to the light source 2 the focusing patterns are, the larger the distances W′ between the focusing patterns are. This can also achieve the same effect as the first embodiment.

What is claimed is:

1. A photoconductive structure of backlight module, comprising a photoconductive board, a light source, a reflecting board and a brightening film, wherein:
one of top face and bottom face of the photoconductive board is formed with multiple photoconductive patterns which are concentric arches centered at the light source;
the reflecting board is disposed on one of the top face and bottom face of the photoconductive board; and
the brightening film is disposed on the other of the top face and bottom face of the photoconductive board, one of the top face and bottom face of the brightening film being formed with multiple focusing patterns arranged in the same aspect as the photoconductive patterns of the photoconductive board.

2. A brightening film of backlight module, one of top face and bottom face of the brightening film being formed with multiple focusing patterns, which are concentric, arches centered at a light source of the backlight module.

3. The photoconductive structure of backlight module as claimed in claim 1, wherein the photoconductive patterns of the photoconductive board are spaced from each other by a distance and the closer to the light source the photoconductive patterns are, the larger the distance between the photoconductive patterns is.

4. The photoconductive structure of backlight module as claimed in claim 1, wherein the photoconductive patterns of the photoconductive board are all projecting structures.

5. The photoconductive structure of backlight module as claimed in claim 1, wherein the photoconductive patterns of the photoconductive board are all recessed structures.

6. The photoconductive structure of backlight module as claimed in claim 1, wherein the focusing patterns of the brightening film are projecting structures the cross-section of which is V-shaped.

7. The photoconductive structure of backlight module as claimed in claim 1, wherein the photoconductive patterns of the photoconductive board are all structures the cross-section of which is V-shaped.

8. The photoconductive structure of backlight module as claimed in claim 1, wherein the photoconductive patterns of the photoconductive board are all structures the cross-section of which is arched.

9. The photoconductive structure of backlight module as claimed in claim 1, wherein the light source is positioned adjacent to a corner of the photoconductive board.

10. The photoconductive structure of backlight module as claimed in claim 1, wherein the light source is positioned at a corner of the photoconductive board.

11. The brightening film of backlight module as claimed in claim 2, wherein the focusing pattern are spaced from each other by a distance and the closer to the light source the focusing patterns are, the larger the distance between the focusing patterns is.

12. The brightening film of backlight module as claimed in claim 2, wherein the focusing patterns are projecting structures the cross-section of which is V-shaped.
